(19) United States
(12) Patent Application Publication
(10) Pub. No.: US 2022/0333335 A1
(43) Pub. Date: Oct. 20, 2022

(54) FOLDING FORM FOR THE CONSTRUCTION OF STRUCTURAL WALLS

(71) Applicant: Gustavo Adolfo SANTANDER LORA, Aventura, FL (US)

(72) Inventor: Gustavo Adolfo SANTANDER LORA, Aventura, FL (US)

(21) Appl. No.: 17/763,065

(22) PCT Filed: Sep. 23, 2019
(86) PCT No.: PCT/IB2019/058038

§ 371 Date: Mar. 23, 2022

(51) Int. Cl. E02D 29/02; A01G 9/02

(52) U.S. Cl. CPC E02D 29/0275; A01G 9/025; E02D 2300/0045; E02D 2600/40; E02D 2300/002; E02D 2250/0023

(57) ABSTRACT

The present invention relates to a self-supporting, prefabricated, folding form structure or mechanism to be used in the construction industry. It is based on various types of geometries, providing enhanced strength and stability for the concrete and other building material casting process. The object of this invention is a foldable, prefabricated, self-supporting form and does not require a structure. It is configured in a variety of geometric shapes and is based on structural elements that have internal casting chambers or ducts interconnected between each other through perforated holes. This is done by means of internal assembly channels or cavities forming casting chambers. The casting chambers are interconnected with each other, through holes drilled in the structural elements. This way the form features an assembly between its walls through cracks or assembly cuts, creating an architecture of superior engineering that provides higher resistance and stability.

### FIELD OF THE INVENTION

The present invention is related to the technical field of construction systems, especially with structures and mechanisms of forms for concrete casting and molding. Particularly, the present invention refers to a structure or mechanism of folding, prefabricated, self-supporting form, to be applied in the construction industry, which is based on various types of geometries providing superior resistance and stability for the concrete and other construction material casting process.

### BACKGROUND OF THE INVENTION

Retaining walls are conceived as a type of rigid retaining structure, intended to contain different types of materials.

Since ancient times, various types of load-bearing walls have been built, from adobe, stone, through pastes and mortars that are precursors to concrete. The Romans promoted the use and application of concrete through a technique known as Emplectum, consisting of creating two outer sheets of stone ashlars, filled with a lime-sand-rubber mortar. This construction technique has been repeated with variants throughout history.

Sometimes stone was replaced by mud in the form of adobe, that is, a sun-dried mud brick.

In turn, the technique known as mud wall involves a form of construction consisting of imprisoning mud between two laminates or wooden formwork, which is later compacted into successive layers using mallets or rammers.

The most used material to build load-bearing walls is brick, which originated as an evolution of adobe, whose difference lies in the firing process that gives it superior strength and durability. A variant of the brick load-bearing wall is the one made with concrete block.

Currently, concrete is confined through formworks until it sets and hardens.

In turn, the emergence of steel, capable of withstanding tensile stresses, made possible the appearance of reinforced concrete and metal structures, which radically modified the building methods, rendering load-bearing walls obsolete. At present, these walls are only used in minor works, such as soil retaining walls, in public works and in basements, the rest of the structure being a combination of beams and pillars, so the walls rarely carry out load-bearing or structural functions, and their sole purpose is to compartmentalize or isolate spaces.

Until the end of the 19th century, masonry and stone walls were built. From the 20th century mass concrete and reinforced concrete walls began to be built, largely displacing the previously used materials.

This is how the retaining wall construction industry has traditionally used the manufacture of various types of forms or formwork in materials such as wood, agglomerates or metals in general, within which the concrete is poured.

Another alternative in manufacturing retaining walls is the use of concrete blocks, which are reinforced with steel rods and poured concrete.

However, in the technical field of the construction of retaining walls, there are no effective solutions that allow to dump the material in an agile, prefabricated, ultra-light, cost-effective way and with an ultimate design, such as the one provided by the present invention. For example, in the field of patents related to the state of the art close to the invention, document CA2988452 reveals a structural wall with a wooden, metal, plastic, polycarbonate or another resistant material structure having no diagonal or cross reinforcement blocks in its longitudinal axis or, by default, its structure is reticulated and/or articulated. This wall obtains the necessary rigidity through a structure external to its longitudinal axis by means of different diagonal elements, fixed to the vertical structural elements or pillars, to allow the pouring or filling inside with materials that give habitability benefits to this wall.

Patent application CN103132630 relates to a cellular slab, prefabricated foamed cement construction wall. Hexagonal prismatic bodies which are made of foamed plastic are combined into a steel wire net. The steel wire net screen is in the shape of an equilateral triangle. A pyramid-shaped positioning box which is made of hard plastic attaches the steel cable to the net to secure the positioning. This way, honeycomb-shaped spaces can be formed between the foamed-plastic hexagonal prismatic bodies. The honeycomb-shaped building wall body is created when foamed cement is poured into the spaces. The slab-type precast foamed cellular cement construction wall can be used in all kinds of buildings.

Under these conditions, the present invention solves the problem related to the construction of retaining walls by means of a folding, prefabricated, self-supporting tailor-made mass-cut mechanism or structure form, based on light and inexpensive products.

### BRIEF DESCRIPTION OF THE INVENTION

In the first observation, the invention is a mechanism or structure of a folding, prefabricated, self-supporting form, which does not require a structure. It is configured in different geometric shapes, based on internal casting chambers or ducts, interconnected between each other through perforated holes. The form has an assembly between its walls through fissures or assembly cuts, creating an architecture and engineering of superior resistance and stability.

In the preferred modality of the invention, the form has a stepped pyramid geometric shape, for the construction of retaining walls.

Notwithstanding the foregoing, the form can be applied in different and varied uses with different types of geometry.

In the preferred modality of the invention, the configuration of the system is based on a form from main structural elements modules and cross elements, using lightweight materials, such as cardboard, plastic or similar lightweight materials, which are coupled by means of died channels in the material of the form, providing a staggered geometry, which in turn, produces multiple figures.

In this modality, the staggered pyramidal geometry from the joining of the form modules allows to dump the mixture to be chosen, including but not limited to, materials such as sand, gravel, cement and mixtures thereof, as well as natural soil, incorporating enzymes, making up retaining walls and architectural figures of superior resistance and stability, which in turn, are likely to be covered with soil, different types of plants and decorative vegetation.

Additionally, the modules of the prefabricated form can be mass-cut using any die cut method or laser technology. This way the form of the present invention is tailor-made, using both light and inexpensive products.

This foldable form mechanism or structure facilitates the dumping and retention of the filling material, while said material undergoes the setting (drying) stage and produces the desired retention result.

The invention provides a practical, agile and economical solution to build retaining walls and various types of complementary applications.

The objects described above, as well as the relevant additional objects, will be explained in detail and with the necessary sufficiency in the descriptive chapter below, which is the basis of the claims chapter.

### BRIEF DESCRIPTION OF THE FIGURES

FIG. 1 shows a perspective view of a preferred modality of the folding form that is the object of the present invention, both empty and full.

FIG. 2 shows a perspective of the main structural elements and the terminal structural elements of the form that is the object of the present invention.

FIG. 3 shows an example of the assembly of the folding form of the present invention.

FIG. 4 shows an example of how the form of the present invention is applied.

FIG. 5 shows a second example of how the form that is the object of the present invention is applied.

FIG. 6 shows a third example of how the formwork that is the object of the present invention is applied.

FIG. 7 shows a fourth example of how the form that is the object of the present invention is applied.

FIG. 8 shows a fifth example of how the formwork that is the object of the present invention is applied.

FIG. 9 shows a lateral detail of the assembly cuts present in a preferred modality of the main structural elements of the form that is the object of the present invention.

FIG. 10 shows a preferred modality of the form that is the object of the present invention with stiffening elements.

FIG. 11 shows a schematic illustration of a layer casting process carried out on the foldable form that is the object of the present invention.

FIG. 12 shows different applications of the folding form that is the object of the present invention.

FIG. 13 shows an example of the coating with soil, plants, decorative vegetation and mixtures thereof that can be applied to the form that is the object of the present invention.

### DETAILED DESCRIPTION OF THE INVENTION

The figures show the following details:

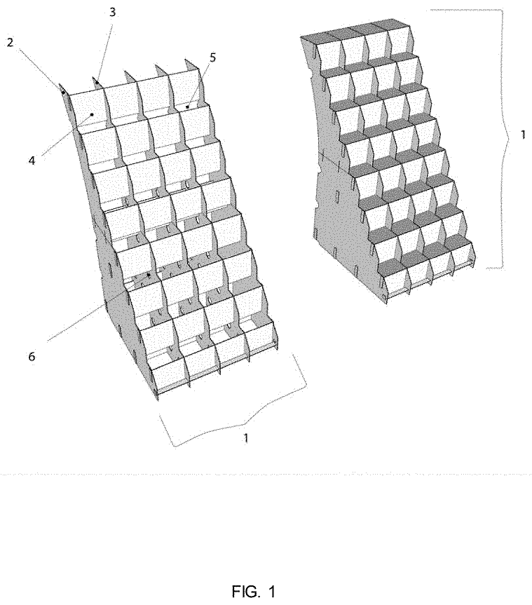

FIG. 1 shows a perspective of one of the modalities of both the empty and full folding form (1), with a stepped pyramidal geometry configured by joining terminal structural elements (2), main structural elements (3) and cross elements (4) that make up the casting chambers (5) that interconnect with each other, through perforated holes (6).

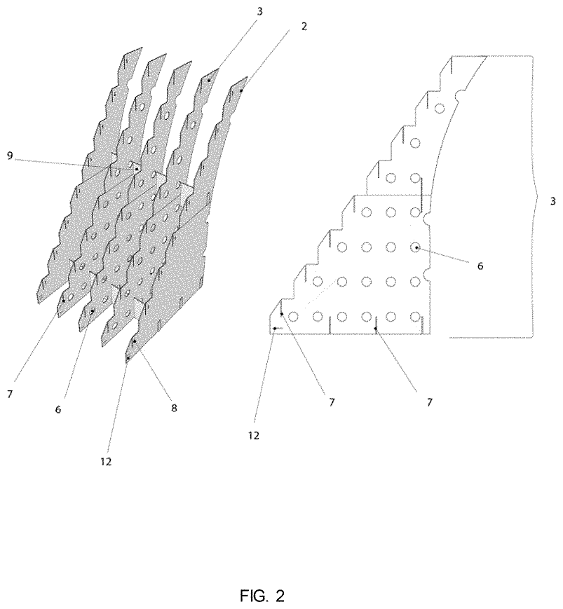

FIG. 2 shows a perspective of the form (1) assembled by means of terminal structural elements (2), main structural elements (3) and cross elements (4), which define casting chambers (5) that are interconnected through perforated holes (6). A schematic view of an internal structural element (3) is also illustrated, which has vertical assembly channels or slots (7), assembly cuts (8) and horizontal perforations (12).

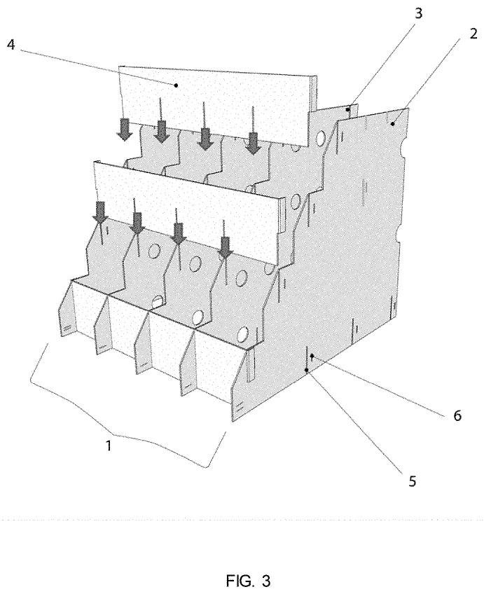

FIG. 3 shows an example of the casting chamber assembly (5) of a modality of the folding form (1) that is the object of the present invention. This preferred modality contains a plurality of cross elements (4) assembled perpendicularly to the terminal structural elements (2) and to the main structural elements (3) by means of vertical assembly channels or slots (5). In a preferred modality, said vertical assembly channels or slots (5) are previously cut or die cut.

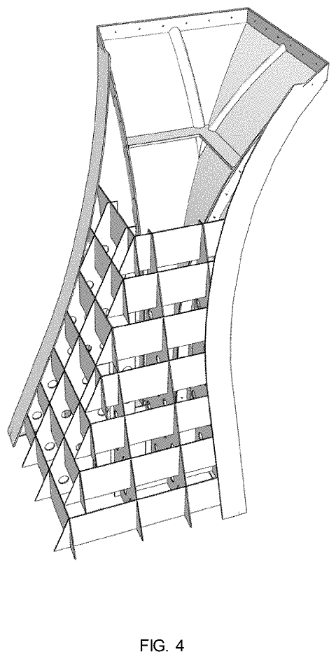

FIG. 4 shows an example of application of the form (1) that is the object of the present invention to build column-type retaining walls. In this case, without limiting the scope of the present invention, the terminal structural elements (2), the main structural elements (3) and the cross elements (4) have a varied geometry.

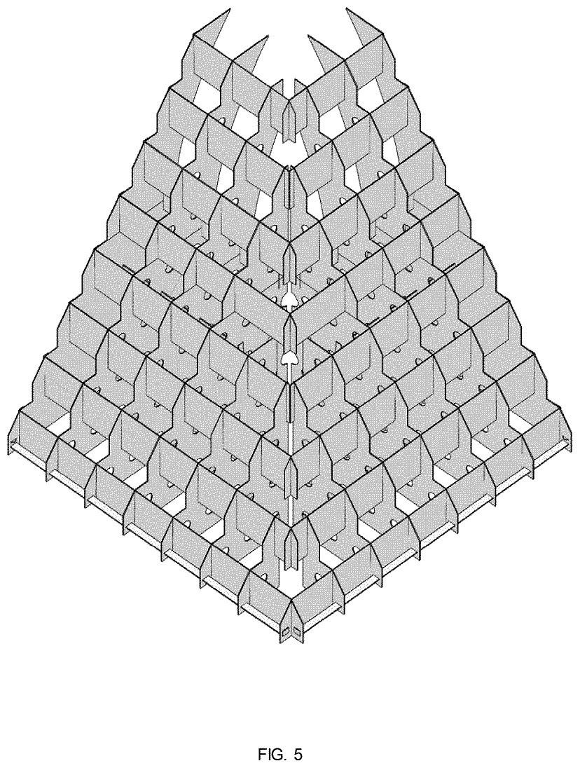

FIG. 5 shows an example of application of the form (1) that is the object of the present invention to build corner or ninety degrees change of direction retaining walls. Please note that the staggered geometry is harmonically preserved.

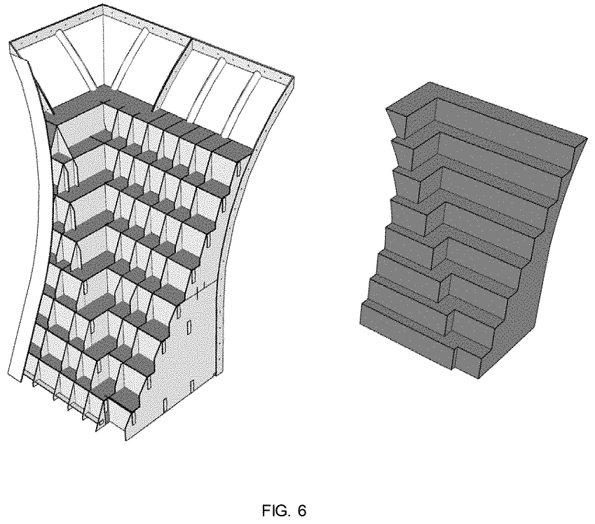

FIG. 6 shows an example of application of the form (1) that is the object of the present invention. In this application example, without this limiting the scope of the present invention, the form (1) is used to build retaining walls in a ninety degree interior joint. A geometric resolution with a varied shape is presented.

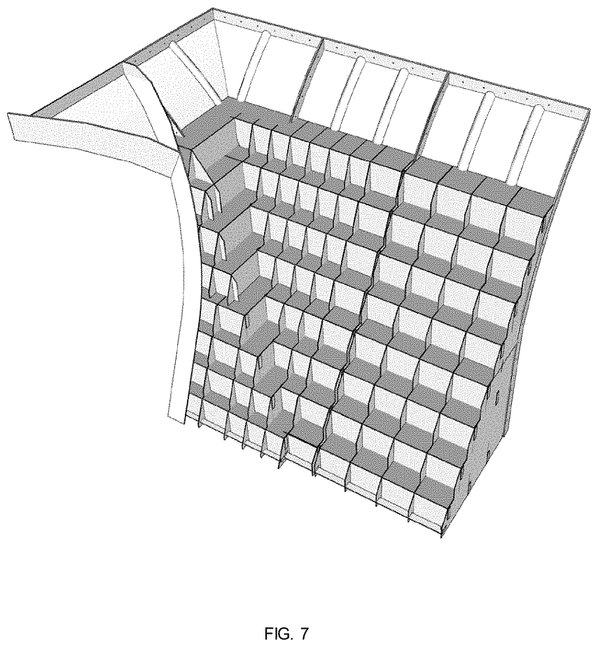

FIG. 7 shows an example of the application of the form (1) that is the object of the present invention. In this application example, without this limiting the scope of the present invention, a geometric resolution with a varied shape is presented.

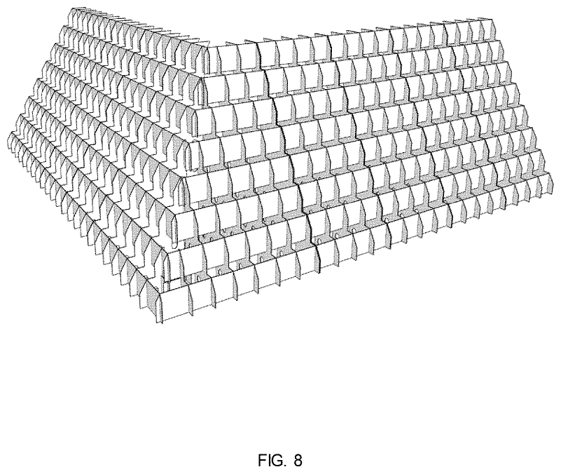

FIG. 8 shows a preferred modality of the form (1) that is the object of the present invention. In this example and without this limiting the scope of the present invention, the casting chambers (5) are obtained by means of a previous laser cutting or die cutting of the terminal structural elements (2), the main structural elements (3) and the cross elements (4). This allows perfect assembly between said elements and the modular growth of the form (1).

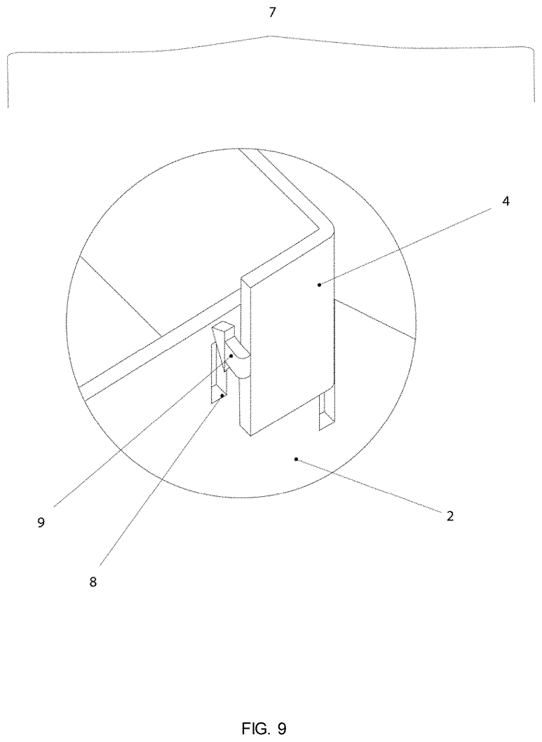

FIG. 9 shows a side detail of a preferred modality of the form (1) that is the object of the present invention. Specifically, it shows an ideal coupling between a terminal structural element (2) and a cross element (4). In this preferred modality, without this limiting the scope of the present invention, said terminal structural element (2) has an assembly cut (8) and said cross element (4) has (9) an arrow-shape projection and can be coupled to said assembly cut (8).

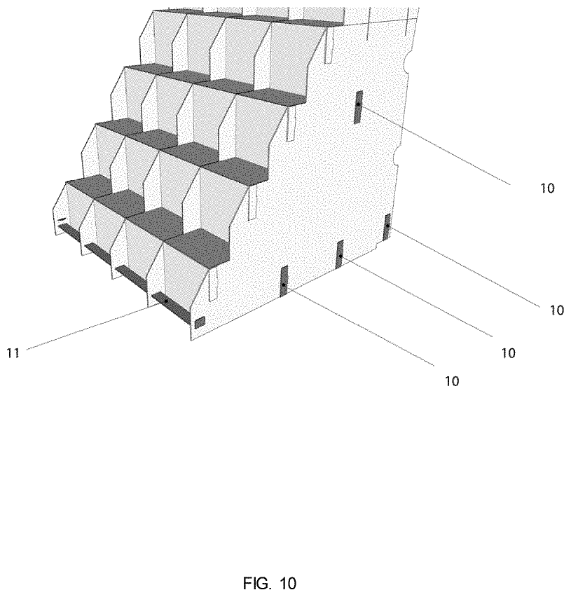

FIG. 10 shows a preferred modality of the present invention where the form (1) has stiffening elements (10) located perpendicularly to provide rigidity to the form (1). In this preferred modality, in addition and without this limiting the scope of the present invention, the form (1) has a central bonding element (11) acting as a tensor. Both said stiffening elements (10) and said central bond element (11) perform as a beam once the structure has been built.

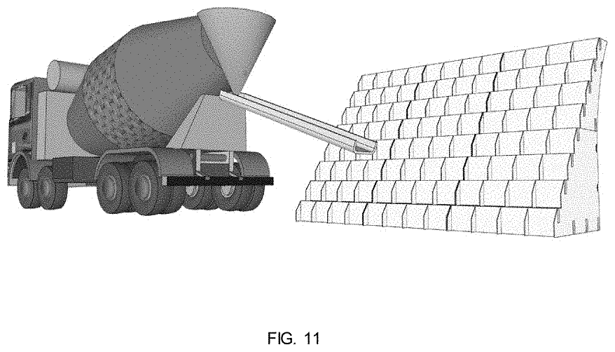

FIG. 11 shows a schematic illustration of a casting process carried out on a preferred modality of the form (1) that is the object of the present invention. Due to the staggered structure of the form (1), without this limiting the scope of the present invention, it is possible to carry out the casting in layers.

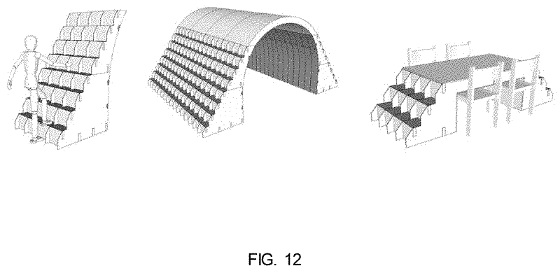

FIG. 12 shows different types of application of the form (1) that is the object of the present invention. These examples are to be understood as illustrative only, but do not limit the scope of the present invention. In a first application example, it is shown that the form (1) can be used to build stairs. In a second example, it is observed that the form (1) can be used to obtain habitable spaces. In a third example, it can be seen that the form (1) can be used in manufacturing furniture.

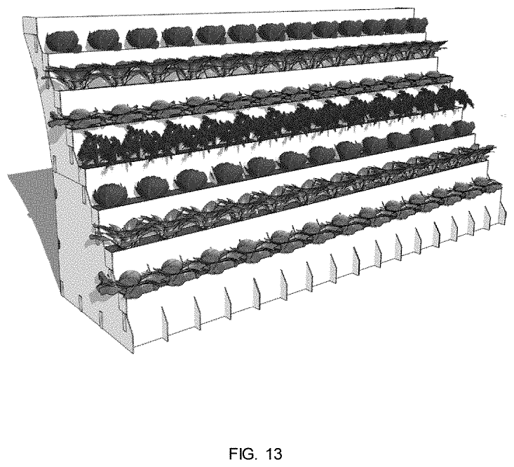

FIG. 13 shows an example of application of the form (1) that is the object of the present invention. In this example, without this limiting the scope of the present invention, part of the form (1) is covered with soil, plants, decorative vegetation and mixtures thereof. In this way, without this limiting the scope of the present invention it is possible to obtain structures with decorative features.

The present invention satisfies the need to provide an effective, agile and cost-effective mechanism to build retaining walls and various types of complementary applications, of superior resistance and stability, which in turn, are susceptible of being covered with soil, different types of plants, decorative vegetation and mixtures thereof.

The description of the modality of the present invention is not intended to limit its scope, but rather to serve as a particular example thereof. A person skilled in the art is expected to understand that the equivalent modalities do not depart from the spirit and scope of the present invention in the widest extent possible.

For a better understanding of the present invention, certain technical terms used in its description will be detailed below.

In the context of the present invention, “form” will be understood as the system that functions as a set of casting chambers, understood as modules or molds, in which the concrete and other materials are poured.

The concrete or other materials are poured into the form where the setting or drying process takes place.

The form (1) object of the present invention comprises a plurality of terminal structural elements (2) that carry a plurality of assembly channels or cavities (7); a plurality of main structural elements (3) that have a plurality of perforated holes (6) inside and a plurality of assembly channels or cavities (7); and a plurality of cross elements (4) that have a plurality of assembly channels or cavities (7) and that are connected transversely to said terminal structural elements (2) and to said main structural elements (3) by means of said assembly channels or cavities (7), creating casting chambers (5). Additionally, said casting chambers (5) are interconnected with each other, through said perforated holes (6) in the main structural elements (3).

In a preferred modality of the invention, said terminal structural elements (2), said main structural elements (3) and said cross elements (3) that are part of the form (1), object of the present invention, are manufactured from a lightweight material that can be selected, for example, and without limiting the scope of the present invention, from the group consisting of cardboard, corrugated cardboard, wood, plastic wood, metals, aluminum, rigid polyethylene plastics, polypropylene, nylon, Teflon, PVC, methacrylate, and rigid laminate materials, as well as combinations thereof.

With respect to said terminal structural elements (2) and said main structural elements (3), they can have any shape imagined by a person with average knowledge in the technical field without this limiting the scope of the present invention. In a preferred modality, the surface of said terminal structural elements (2) and said main structural elements (3) may have the shape of polygons, orthogonal polygons, pentagons, hexagons, warped polygons where the sides do not meet on the same plane, and figures composed of lines and curves arranged in a three-dimensional space.

In a preferred modality of the invention, the form (1) is applied to build retaining walls. In this preferred modality, without this limiting the scope of the present invention, the form (1) is made up of terminal structural elements (2), main structural elements (3) and cross elements (4) that are previously laser cut or die cut. This preferred modality, for example, and without limiting the scope of the present invention, allows said terminal structural elements (2), said main structural elements (3) and said cross elements (4) to form the casting chambers (5) in a staggered pyramidal shape, creating various geometric shapes.

In another preferred modality of the present invention, without this limiting the scope of the requested protection, the assembly channels or cavities (7), which are present in said terminal structural elements (2), said main structural elements (3) and said cross elements (4) are previously laser cut or die cut. This preferred modality, without this limiting the scope of the present invention, has the advantage that said laser cutting or die-cutting allows said assembly channels or cavities (7) to be given a special geometry that adapts precisely to the shape of the structure to be reinforced or contained. In this way, without limiting the scope of the present invention, said terminal structural elements (2), said main structural elements (3) and said cross elements (4) can be coupled with each other with much precision and allow the form (1) that is the object of the present invention to grow in a modular fashion as necessary, as shown schematically in FIG. 8.

As previously mentioned, the main structural elements (3) that are part of the form (1) that is the object of the present invention, comprise perforated holes (6) that join together the casting chambers (5) defined in the form (1). Said perforated holes (6) allow the dumping to be connected through the different casting chambers (5) to create the desired geometry of the form (1) in a monolithic structure.

As shown in FIG. 3, the cross elements (4) are connected transversely to the terminal structural elements (2) and/or to the main structural elements (3). For this, internal assembly channels or cavities (7) are provided, which allows, in this way, to form the respective casting chambers (5), providing the necessary rigidity to the form (1) object of the present invention.

The form (1), object of the present invention has various types of geometries with different inclination angles. This is as foldable, be prefabricated, self-supporting, tailor-made form, cut or die-cut in series; it does not require glue or any type of adhesive, and it is made from light and cost-effective products.

In a preferred modality of the present invention, without this limiting its scope, the geometry of the form (1) is ensured by means of an assembly or joining element present in at least two of the form terminal structural elements (2) or the main structural elements (3) (1). Said assembly or joining element comprises internal assembly cuts (8). Additionally, in this preferred modality, at least one of the cross elements (4) has fixing and coupling elements (9) matching said internal assembly cuts (8); for example, but not limited to, projections that ensure the desired geometry and then allow the dumping process being shaped up with the respective architecture, creating a monolithic body result.

The internal assembly cuts (8) are presented in the folding form (1) object of the present invention depending on the shape of the casting chambers (3).

As shown in FIG. 9, in a preferred modality of the invention, without this limiting the scope of the present invention, said fixing and coupling elements (9) may have a T-type or arrow shape.

As seen schematically in FIG. 10, and without this limiting the scope of the present invention, in a preferred modality the form (1) can have stiffening elements (10). Said materials may be inside said form (1) and perpendicular to the main structural elements (3). In a more preferred modality, as shown in FIG. 10 and without this limiting the scope of the present invention, the form (1) may have a stiffening element (10) located as a central bond (11) functioning as a tension member. Both the stiffening elements (10) and the central bond (11) can operate as a beam, without this limiting the scope of the present invention. The stiffening elements (10) and the central bond stiffening element (11) can be made from the same material of the terminal structural elements (2), the main structural elements (3) or the cross elements (4) that make up the casting chambers (5) of the form (1).

Examples of application of the form (1) object of the present invention will be described below. Said examples are intended to provide a better understanding of the invention, but do not limit its scope. Additionally, technical characteristics described in different examples can be combined with each other, or with any of the previously detailed technical characteristics, in any way imagined by a person with average knowledge in the technical field, without limiting the scope of the present invention.

### Application of the Form to Build Retaining Walls

The form (1) can be assembled and subsequently be subject to a casting process without surrounding elements; or it can be abutted against a curved or flat surface to act as a retaining wall or construction wall.

The resistance of the retaining walls will depend on the casting material chosen. The walls can be covered with concrete, soil, natural gardens, sand, straw, wood and all kinds of exterior finishes.

The dumping into the form must be done on a firm and compact floor. The form (1) is quick and easy to assemble and dumping is completed in a few hours. For the particular case of the construction of retaining walls, the geometry of the form (1) must be based on stepped molds, thus resulting in an inclined wall that offers much greater retaining strength than a vertical wall.

The dumping process is carried out in layers, step by step. Each layer must undergo the corresponding setting or drying process before the subsequent layer is poured.

In the case of a (1) corrugated cardboard form, the dumping takes place in 5 to 100 cm layers. These values may be modified according to the material used in the manufacture of the form (1).

### Other Applications

The form (1) can have various applications, such as stair casting, construction of living spaces, porches, columns, furniture construction (FIG. 12) and all kinds of architectural forms for practical or decorative use.

The casting chambers (5) of the form can be made of non-degradable material and can be used as cultivation beds, for which they can be filled with fertile soil (FIG. 13).

In addition to the consequent pouring with concrete, the casting chambers of the form (1) can be covered with natural soil or fertile soil and different types of vegetation (FIG. 14).

Although the present invention has been described with the preferred modalities shown, it is understood that any modification or variation that retains the spirit and scope of this invention is intended to be within the scope of the appended claims.

### LIST OF REFERENCES

Folding form (1)
Terminal structural element (2)
Main structural element (3)
Cross element (4)
Casting chambers (5)
Drilled holes (6).
Assembly channels or cavities (7)
Internal assembly cutouts (8)
Fixing and coupling elements (9)
Stiffening elements (10)
Central bonding element (11)
Horizontal drilling (12).

1. A form comprising:
a plurality of terminal structural elements having a plurality of assembly channels or cavities;
a plurality of main structural elements that have a plurality of perforated holes inside and a plurality of assembly channels or cavities; and
a plurality of cross elements that have a plurality of assembly channels or cavities and that are connected transversely to said terminal structural elements or to said main structural elements by means of said assembly channels or cavities, forming casting chambers;
wherein said casting chambers are interconnected with each other, through said perforated holes in the main structural elements.

2. The form of claim 1, wherein said terminal structural elements, said main structural elements, and said cross elements are previously laser cut or die cut.

3. The form of claim 1, wherein said assembly channels or cavities are previously laser cut or die cut.

4. The form of claim 1, wherein said main structural elements are arranged forming a stepped pyramidal geometry.

5. The form of claim 1, CHARACTERIZED because the surface of said terminal structural elements, and said main structural elements have a surface shape selected from the group that includes regular polygons, orthogonal polygons, pentagons, hexagons, warped polygons where the sides are not in the same plane, and figures composed of lines and curves arranged in a three-dimensional space.

6. The form of claim 1, wherein at least two of said main structural elements or of said terminal structural elements have an assembly or joining element comprising internal assembly cuts and because at least one of the cross elements has fixing and coupling elements that correspond to said internal assembly cuts.

7. The form of claim 6, wherein said fixing and coupling elements are of the T or arrow type.

8. The form of claim 1, wherein said terminal structural elements, said main structural elements, and said cross elements are made of plastic cardboard.

9. The form of claim 1, wherein said terminal structural elements, said main structural elements, and said cross elements are made of a material selected from the group consisting of cardboard, corrugated cardboard, wood, plastic wood, metals, aluminum, rigid polyethylene plastics, polypropylene, nylon, Teflon, PVC, methacrylate, and rigid laminate materials, as well as combinations thereof.

10. The form of claim 1, further comprising stiffening elements that are located inside said form and perpendicularly to the main structural elements.

11. The form of claim 10, wherein said stiffening elements are made of the same material as the main structural elements.

12. The form of claim 10, wherein it comprises stiffening elements placed as a central bond.

13. The form of claim 1, further comprising concrete casting layers.

14. The form of claim 1, further comprising casting layers made of sand, gravel, cement, natural soil, volcanic waste, polystyrene, or combinations thereof.

15. The form of claim 1, further comprising a covering of soil, plants, decorative vegetation, or mixtures thereof.

16. The form of claim 1, wherein it is foldable.

17. The form of claim 1, wherein it is used for the construction of retaining walls.
